(19) United States
(12) Patent Application Publication
(10) Pub. No.: US 2016/0046132 A1
(43) Pub. Date: Feb. 18, 2016

(54) LASER PROCESSING APPARATUS AND PRINTING APPARATUS

(71) Applicant: SEIKO EPSON CORPORATION, Tokyo (JP)

(72) Inventors: Daiki TOKUSHIMA, Suwa-shi (JP); Kiyoshi HASHIMOTO, Shiojiri-shi (JP)

(21) Appl. No.: 14/824,206

(22) Filed: Aug. 12, 2015

(30) Foreign Application Priority Data
Aug. 13, 2014 (JP) 2014-164731

(51) Int. Cl. B41J 2/455

(52) U.S. Cl. CPC B41J 2/455

(57) ABSTRACT

A laser processing apparatus includes a transport unit that transports a continuous label member having an adhesive surface to which a liner is affixed while separating the liner from the continuous label member at a separating position, and transports the continuous label member from which the liner has been separated while affixing the liner to the adhesive surface at an affixing position located downstream from the separating position, and a laser irradiator that forms in the continuous label member a cut line enabling the continuous label member to be cut by irradiating the continuous label member, whose adhesive surface is exposed due to the liner being separated, with a laser beam at an irradiation position located between the separating position P1 and the affixing position.

### BACKGROUND

1. Technical Field

The present invention relates to laser processing apparatuses and printing apparatuses that manufacture labels through laser irradiation.

2. Related Art

A label die-cutting apparatus including a travel path along which label base paper having label paper on a back surface of which an adhesive is spread and a label backing affixed to the back surface of the label paper travels in a straight line, a diversion path along which the label backing separated from the label paper is diverted between two backing guide rollers, a dummy paper travel path provided on an inner side of the diversion path in which dummy paper travels in a loop so as to overlap with the back surface side of the label paper, and a laser irradiator that irradiates, with a laser beam, the label paper traveling with the dummy paper superimposed on the back surface side thereof from the front surface of the label paper so that a label is punched out, has been known for some time. This label die-cutting apparatus prevents cuts from being formed in the label backing due to the laser irradiation by irradiating the label paper with a laser beam after the label paper has been separated from the label backing (see JP-A-2013-095005).

The inventors of the present application discovered the following problems.

When dummy paper is used in a laser processing apparatuses as in the stated past label die-cutting apparatus, cuts are formed in the dummy paper by the laser beam irradiation, and it is thus necessary to replace the dummy paper. In this case, it is necessary to stop the apparatus in order to replace the dummy paper, which causes a drop in production efficiency.

### SUMMARY

It is an advantage of some aspects of the invention to provide a laser processing apparatus and a printing apparatus capable of suppressing a drop in production efficiency.

A laser processing apparatus according to an aspect of the invention includes a transport unit that transports a continuous label member having an adhesive surface to which a liner is affixed while separating the liner from the continuous label member at a separating position, and transports the continuous label member from which the liner has been separated while affixing the liner to the adhesive surface at an affixing position located downstream from the separating position, and a laser irradiating unit that forms in the continuous label member a cut line enabling the continuous label member to be cut by irradiating the continuous label member, whose adhesive surface is exposed due to the liner being separated, with a laser beam at an irradiation position located between the separating position and the affixing position.

According to this configuration, the laser processing apparatus forms the cut line in the continuous label member by irradiating the continuous label member whose adhesive surface is exposed with a laser beam, without using dummy paper. Accordingly, it is not necessary to stop the apparatus in order to replace the dummy paper, which makes it possible to suppress a drop in production efficiency.

In this case, it is preferable that the laser irradiating unit irradiate the continuous label member with a laser beam on the opposite side from the adhesive surface, and that the apparatus further include a shield member, provided between the continuous label member whose adhesive surface is exposed and the liner separated from the continuous label member, that blocks laser light that has passed through the continuous label member.

According to this configuration, the laser processing apparatus can suppress the liner that has been separated from the continuous label member from being irradiated with the laser beam. Accordingly, cuts can be suppressed from being formed in the liner, which has been separated from the continuous label member, due to the laser irradiation.

In this case, it is preferable that a surface of the shield member that faces the continuous label member function as an adhesion suppressing surface that suppresses the adhesive surface from adhering to the shield member.

According to this configuration, the laser processing apparatus can suppress the adhesive surface of the continuous label member from which the liner has been separated from adhering to the shield member.

In this case, it is preferable that the laser irradiating unit form the cut line having a cut remnant portion.

According to this configuration, a cutout portion surrounded by the cut line can be suppressed from separating from the continuous label member while the continuous label member is being transported.

A printing apparatus according to another aspect of the invention includes the aforementioned laser processing apparatus and a printing unit that prints an image onto a print surface of the continuous label member that is on the opposite side from the adhesive surface.

### BRIEF DESCRIPTION OF THE DRAWINGS

The invention will be described with reference to the accompanying drawings, wherein like numbers reference like elements.

FIG. 1 is an overall schematic diagram illustrating a printing apparatus according to an embodiment of the invention.

FIGS. 2A to 2C are diagrams illustrating cut lines formed in a continuous label member.

FIG. 3 is a general schematic diagram illustrating a printing apparatus according to a related technique.

### DESCRIPTION OF EXEMPLARY EMBODIMENTS

Hereinafter, a printing apparatus according to an embodiment of the invention will be described with reference to the appended drawings. The printing apparatus according to this embodiment prints an image onto a medium and, by irradiating the medium with a laser beam, forms a cut line in the medium so that the printed area can be cut out.

First, the medium will be described.

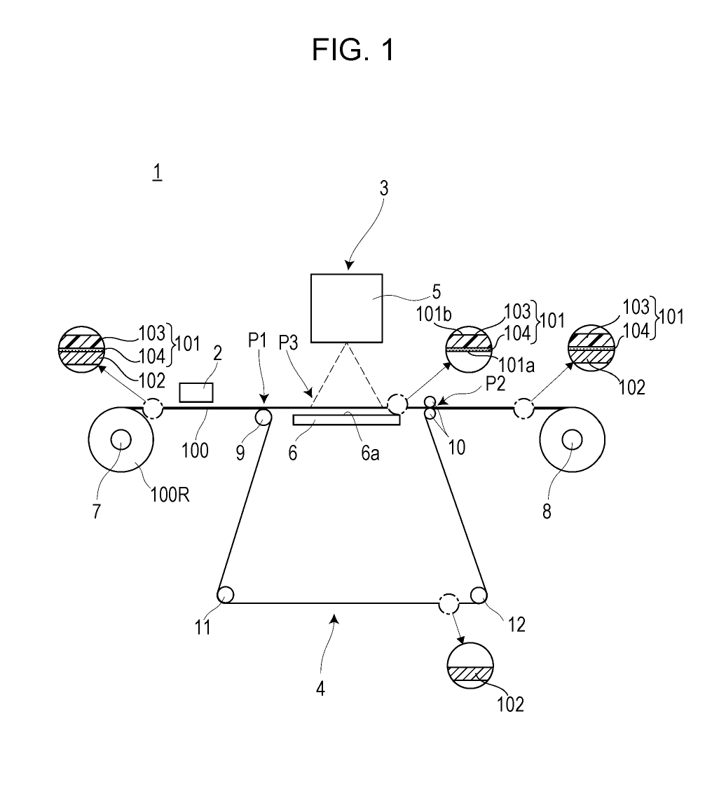

As illustrated in FIG. 1, a medium 100 is a long, band-shaped sheet. The medium 100 includes a continuous label member 101 and a liner 102. The medium 100 is set in a printing apparatus 1 as a label roll 100R, in which the medium 100 is wound into a roll shape with the continuous label member 101 on an outer side of the roll.

One of front and back surfaces of the continuous label member 101 serves as an adhesive surface 101a to which the liner 102 is affixed, and the other of the front and back surfaces of the continuous label member 101 serves as a printing surface 101b onto which an image is printed. The continuous label member 101 has a label base material 103 and an adhesive layer 104. The adhesive layer 104, which forms the adhesive surface 101a, is provided on one of front and back surfaces of the label base material 103, and the other of the front and back surfaces of the label base material 103 serves as the printing surface 101b. The material used for the label base material 103 is not particularly limited, and a variety of materials can be used, including paper-based materials, resin film-based materials, and so on.

The liner 102 is affixed to the adhesive surface 101a of the continuous label member 101. The surface of the liner 102 that is affixed to the adhesive surface 101a of the continuous label member 101 is given a separation treatment such as processing with silicon or the like. The liner 102 can therefore be separated from the continuous label member 101 with ease.

Next, the printing apparatus 1 will be described.

The printing apparatus 1 includes a printing unit 2 and a laser processing unit 3.

The printing unit 2 prints an image onto the printing surface 101b of the continuous label member 101. Note that the printing technique used by the printing unit 2 is not particularly limited, and an ink jet technique, a thermal technique, or the like can be used, for example.

The laser processing unit 3 includes a transport unit 4, a laser irradiator 5, and a shield member 6. The laser irradiator 5 is an example of a “laser irradiating unit”.

The transport unit 4 transports the continuous label member 101 using a roll-to-roll technique. The transport unit 4 includes a feed-out shaft 7, a take-up shaft 8, a separating roller 9, an affixing roller 10 that is a nip roller, a first guide roller 11, and a second guide roller 12.

The feed-out shaft 7 supports the label roll 100R set thereon in a state in which the label roll 100R can be rotated and fed out. The take-up shaft 8 takes up the medium 100 that has been fed out from the label roll 100R and has been printed onto and laser-cut. The take-up shaft 8 is rotationally driven by a take-up shaft drive unit (not shown). Note that the medium 100 taken up onto the take-up shaft 8 is provided to a label affixing apparatus or the like.

The medium 100 fed out from the label roll 100R is separated into the continuous label member 101 and the liner 102 upon traversing the separating roller 9 that makes contact with the liner 102 side of the medium 100. In other words, the liner 102 is separated from the continuous label member 101 at a separating position P1 at which the separating roller 9 is provided. The continuous label member 101 from which the liner 102 has been separated is transported in a straight line from the separating roller 9 to the affixing roller 10, with the exposed adhesive surface 101a facing downward. Meanwhile, the liner 102 separated from the continuous label member 101 is transported downward toward the first guide roller 11 at the position of the separating roller 9, so as to be bent at an acute angle. The liner 102 is guided by the first guide roller 11 and the second guide roller 12, and is then transported toward the affixing roller 10. The continuous label member 101 and the liner 102 then converge upon traversing the affixing roller 10. In other words, the liner 102 is once again affixed to the adhesive surface 101a of the continuous label member 101 at an affixing position P2 at which the affixing roller 10 is provided. The continuous label member 101 to which the liner 102 has been affixed is then taken up onto the take-up shaft 8.

In this manner, the transport unit 4 transports the medium 100, or in other words, the continuous label member 101 in which the liner 102 is affixed to the adhesive surface 101a, while continuously separating the liner 102 at the separating position P1. In addition, the transport unit 4 transports the continuous label member 101 from which the liner 102 has been separated while continuously affixing the liner 102 to the adhesive surface 101a at the affixing position P2. The transport unit 4 transports the continuous label member 101, from which the liner 102 has been separated and whose adhesive surface 101a is therefore exposed, in a straight line between the separating position P1 and the affixing position P2. In addition, between the separating position P1 and the affixing position P2, the transport unit 4 diverts the liner 102 separated from the continuous label member 101 through a lower path that traverses the first guide roller 11 and the second guide roller 12.

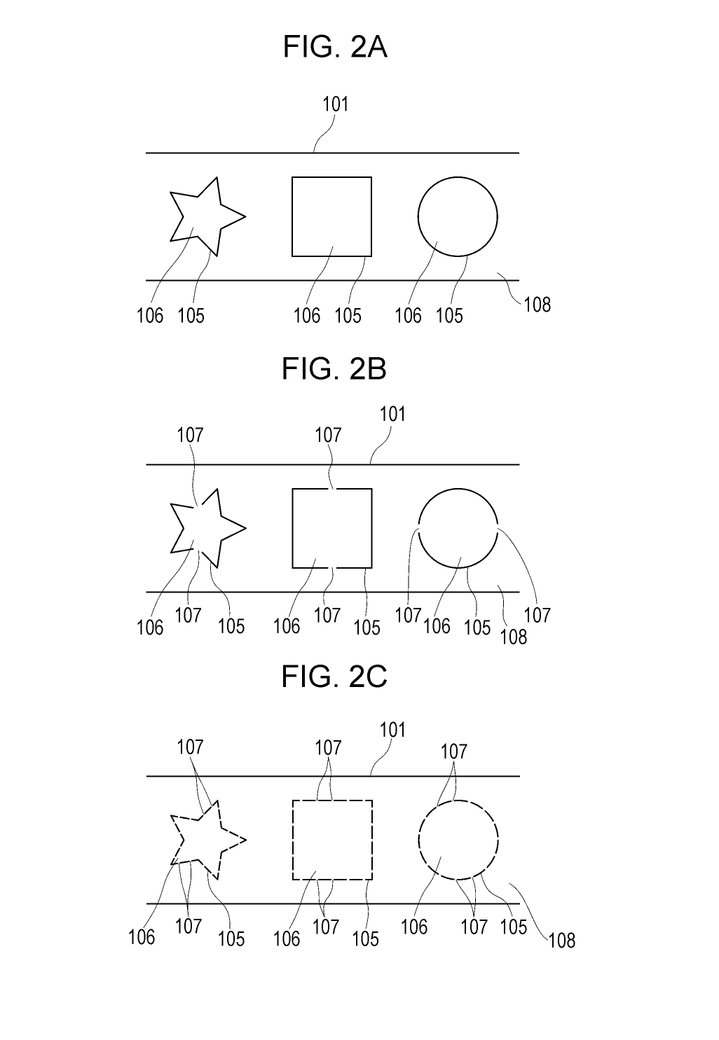

The laser irradiator 5 irradiates the continuous label member 101 whose adhesive surface 101a is exposed with a laser beam from the printing surface 101b side at an irradiation position P3 located between the separating position P1 and the affixing position P2. A cut line 105 that enables the continuous label member 101 to be cut out is formed in the continuous label member 101 as a result of the laser irradiation (see FIGS. 2A to 2C). A cutout portion 106 surrounded by the cut line 105 can be removed from the continuous label member 101 by a label affixing apparatus, a user's hand, or the like and used as a label.

Although not illustrated in the drawings, the laser irradiator 5 includes a laser generation unit and a laser scanning unit that scans the continuous label member 101 one-dimensionally or two-dimensionally with a laser beam. Accordingly, the laser irradiator 5 can form the cut line 105 in a variety of shapes. A carbon dioxide laser, a YAG laser, or the like can be used as the laser generation unit, for example. Meanwhile, a galvano system, an X-Y plotter system, or the like can be used as the laser scanning unit, for example.

The laser irradiator 5 may form a continuous peripheral cut line 105 as illustrated in FIG. 2A, or may form a cut line 105 that contains cut remnant portions 107 as illustrated in FIGS. 2B and 2C. The number of cut remnant portions 107 relative to each cutout portion 106 is not particularly limited, and the cut remnant portions 107 may be provided in two locations (see FIG. 2B), or may be provided in a stitch shape in a plurality of locations (see FIG. 2C), for example. By the laser irradiator 5 forming the cut line 105 containing the cut remnant portions 107 in this manner, the cutout portion 106 can be suppressed from separating from the continuous label member 101 while the continuous label member 101 is being transported.

The shield member 6 is provided between the continuous label member 101 whose adhesive surface 101a is exposed and the liner 102 separated from the continuous label member 101. Any member that blocks laser light passing through the continuous label member 101, or in other words, any member that is not cut by the laser beam emitted from the laser irradiator 5, may be employed as the shield member 6; for example, a metal plate-shaped member can be used. A top surface of the shield member 6, or in other words, a surface of the shield member 6 facing the continuous label member 101, is subjected to a silicon process, for example, so as to function as an adhesion suppressing surface 6a that suppresses the adhesive surface 101a of the continuous label member 101 from adhering thereto.

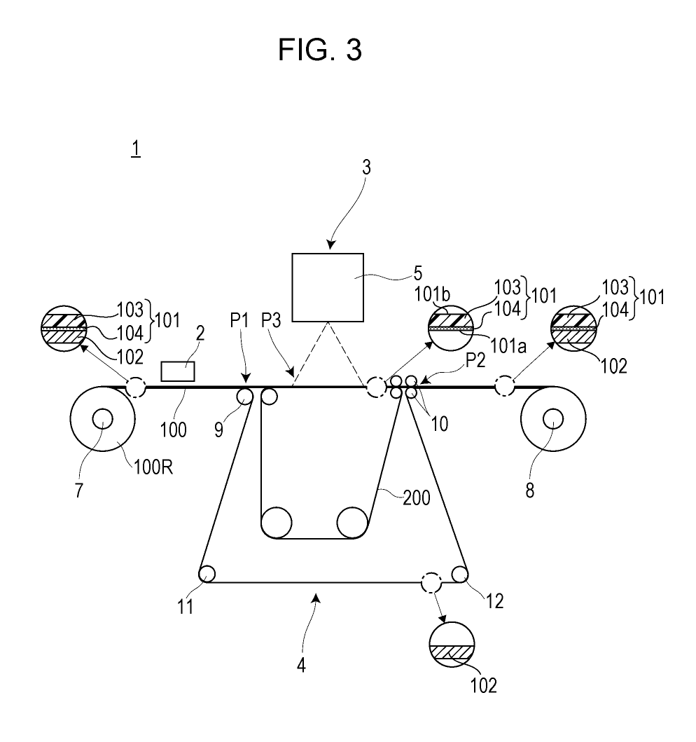

Unlike the printing apparatus 1 according to this embodiment, in the case where, as illustrated in FIG. 3, dummy paper 200 is caused to travel in a loop while superimposed with the liner 102 on the adhesive surface 101a side of the continuous label member 101 from which the liner 102 has been separated in order to prevent the cutout portion 106 from falling out from the continuous label member 101, cut may be formed in the dummy paper 200 due to the laser irradiation. Accordingly, it is necessary to replace the dummy paper 200. In this case, it is necessary to stop the printing apparatus 1 in order to replace the dummy paper 200, which causes a drop in production efficiency.

However, the printing apparatus 1 according to this embodiment does not use the dummy paper 200, and forms the cut line 105 in the continuous label member 101 by irradiating the continuous label member 101, whose adhesive surface 101a is exposed, with a laser beam. Accordingly, it is not necessary to stop the printing apparatus 1 in order to replace the dummy paper 200, which makes it possible to suppress a drop in production efficiency.

If cuts are formed in the liner 102 due to the laser irradiation, a separating member provided in the label affixing apparatus for separating the cutout portion 106 from the liner 102 will become caught on the cuts in the liner 102, and the cutout portion 106 cannot be separated from the liner 102 in a favorable manner. With respect to this point, it is possible to cut only the continuous label member 101 without forming cuts in the liner 102 by making fine adjustments to the laser power. However, such fine power adjustments are not easy to make. Meanwhile, in the case where a comparatively low-power laser is employed so that cuts are not formed in the liner 102, the cut edges of the continuous label member 101 will be melted or burned, causing a drop in the quality of the labels.

As opposed to this, the printing apparatus 1 according to this embodiment irradiates the continuous label member 101, from which the liner 102 has been separated, with a laser beam, and thus cuts can be suppressed from being formed in the liner 102 even in the case where a relatively high-power laser is employed. Accordingly, the cut line 105 can be formed with favorable cut edges, without making fine adjustments to the power of the laser.

Furthermore, the printing apparatus 1 according to this embodiment includes the shield member 6, and thus the liner 102 separated from the continuous label member 101 can be suppressed from being irradiated with the laser beam. Accordingly, cuts can be suppressed from being formed in the liner 102 separated from the continuous label member 101 due to the laser irradiation even in the case where a high-power laser beam has been mistakenly emitted from the laser irradiator 5.

In the printing apparatus 1 according to this embodiment, the surface of the shield member 6 that faces the continuous label member 101 functions as the adhesion suppressing surface 6a. Accordingly, in the printing apparatus 1, even in the case where the continuous label member 101 whose adhesive surface 101a is exposed on the bottom thereof has sagged downward between the separating position P1 and the affixing position P2, the adhesive surface 101a can be suppressed from adhering to the shield member 6 and interfering with the transport of the continuous label member 101.

Note that the invention is not limited to the aforementioned embodiments, and it goes without saying that many configurations can be employed without departing from the essential spirit of the invention. For example, the aforementioned embodiment can be modified in the following manner.

The invention can also be applied in a laser processing apparatus having the same configuration as the laser processing unit 3 but that does not include the printing unit 2.

The transport unit 4 may divert the liner 102 separated from the continuous label member 101 upward, for example, or may divert the liner 102 in a horizontal direction.

The entire disclosure of Japanese Patent Application No. 2014-164731, filed Aug. 13, 2014 is expressly incorporated by reference herein.

What is claimed is:

1. A laser processing apparatus comprising:
a transport unit that transports a continuous label member having an adhesive surface to which a liner is affixed while separating the liner from the continuous label member at a separating position, and transports the continuous label member from which the liner has been separated while affixing the liner to the adhesive surface at an affixing position located downstream from the separating position; and
a laser irradiating unit that forms in the continuous label member a cut line enabling the continuous label member to be cut by irradiating the continuous label member, whose adhesive surface is exposed due to the liner being separated, with a laser beam at an irradiation position located between the separating position and the affixing position.

2. The laser processing apparatus according to claim 1,
wherein the laser irradiating unit irradiates the continuous label member with a laser beam on the opposite side from the adhesive surface, and
the apparatus further comprises:
a shield member, provided between the continuous label member whose adhesive surface is exposed and the liner separated from the continuous label member, that blocks laser light that has passed through the continuous label member.

3. The laser processing apparatus according to claim 2,
wherein a surface of the shield member that faces the continuous label member functions as an adhesion suppressing surface that suppresses the adhesive surface from adhering to the shield member.

4. The laser processing apparatus according to claim 1,
wherein the laser irradiating unit forms the cut line having a cut remnant portion.

5. A printing apparatus comprising:
the laser processing apparatus according to claim 1; and
a printing unit that prints an image onto a print surface of the continuous label member that is on the opposite side from the adhesive surface.

6. A printing apparatus comprising:
the laser processing apparatus according to claim 2; and
a printing unit that prints an image onto a print surface of the continuous label member that is on the opposite side from the adhesive surface.

7. A printing apparatus comprising:
the laser processing apparatus according to claim 3; and
a printing unit that prints an image onto a print surface of the continuous label member that is on the opposite side from the adhesive surface.

8. A printing apparatus comprising:
the laser processing apparatus according to claim 4; and
a printing unit that prints an image onto a print surface of the continuous label member that is on the opposite side from the adhesive surface.
